(19) United States
(12) Patent Application Publication
(10) Pub. No.: US 2009/0271439 A1
(43) Pub. Date: Oct. 29, 2009

(54) SYSTEMS TO IMPLEMENT BUSINESS PROCESSES IN COMPUTING ENVIRONMENT

(76) Inventors: John Hack, Maplewood, NJ (US); Hak Woo Kim, Stamford, CT (US); Christian Gheorghe, Wilton, CT (US)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/241,964

(22) Filed: Sep. 30, 2008

Related U.S. Application Data
(60) Provisional application No. 61/047,145, filed on Apr. 23, 2008.

(51) Int. Cl. G06F 17/00

(52) U.S. Cl. 707/104.1; 707/E17.124

(57) ABSTRACT

A system to identify a markup language file describing a business process, create a mapping of dimensions of the business process to dimensions of a target computing environment, and implement the business process in the target computing system based on the mapping and the markup language file.

### CROSS REFERENCE TO RELATED APPLICATIONS

This application claims priority to U.S. Provisional Patent Application Ser. No. 61/047,145, filed Apr. 23, 2008 and entitled “SYSTEMS TO PROVIDE BUSINESS APPLICATION MARKETPLACE”, the contents of which are incorporated by reference herein for all purposes.

This application is related to commonly-assigned U.S. patent application Serial No. (attorney docket no. 2008P00071US01), filed on even date herewith and entitled “EXTRACTION AND MODELING OF IMPLEMENTED BUSINESS PROCESSES”, the contents of which are incorporated by reference herein for all purposes.

### BACKGROUND

Business software applications are typically delivered to a customer and then manually tailored to the customer's existing systems and workflows within the customer's computing environment. In order to add functionality to an existing computing environment, executable software embodying the functionality must be delivered to the customer and similarly tailored. The foregoing scenario may be too time-consuming, error-prone or expensive for some customers and/or in some scenarios.

Recent systems provide offsite hosting of business applications. Such systems may provide improved access to additional functionality, but force a customer to operate within a default environment provided by the host. Moreover, such systems require a customer to exchange its often-sensitive data with locations outside the customer's firewall.

Systems are desired for efficiently providing additional application functionality into a customer's environment. Such systems may also allow for modification of such functionality to meet customer needs.

### BRIEF DESCRIPTION OF THE DRAWINGS

FIG. 1 is a block diagram of a system according to some embodiments.

FIG. 2 is a flow diagram of a process according to some embodiments.

FIG. 3 is a block diagram of a system according to some embodiments.

FIG. 4 is a flow diagram of a process according to some embodiments.

FIG. 5 is an outward view of a user interface according to some embodiments.

FIG. 6 is an outward view of a user interface according to some embodiments.

FIG. 7 is an outward view of a user interface according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

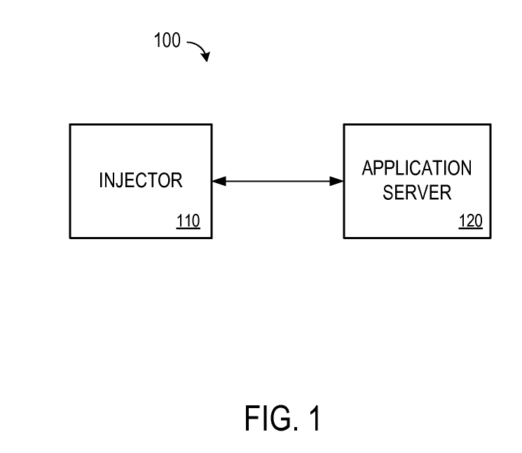

FIG. 1 is a block diagram of system 100 according to some embodiments. System 100 comprises injector 110 and application server 120. The elements of system 100 may be implemented using any combinations of hardware and/or software that are or become known. According to some embodiments, system 100 includes elements in addition to those illustrated in FIG. 1.

Injector 110 may comprise executable program code embodying one or more of the processes to be described herein, and/or computer hardware for executing such program code. Injector 110 may be embodied in a Web Server configured to receive commands from a Web Browser and to invoke Web Services based thereon, in a standalone executable file (e.g., an .exe file) or in code (e.g., a JAVA applet) executable by a virtual machine.

Application server 120 may also comprise hardware and/or software. Application server 120 includes may provide business processes to authorized clients as is known in the art. A business process may comprise pre-implemented software functionality for a target business segment. A business process may include, but is not limited to, functionality related to schedules, reports, ETL processes, management approvals, standard business practices (e.g., revenue forecasts by product line, costs by department), and security. Business processes may guide and coordinate end users toward a common performance management goal such as creating a compliant forecast or statutory-consolidated financial results. Embodiments may comprise any types of business applications, Web Services, and software-provided functions that are or becomes known.

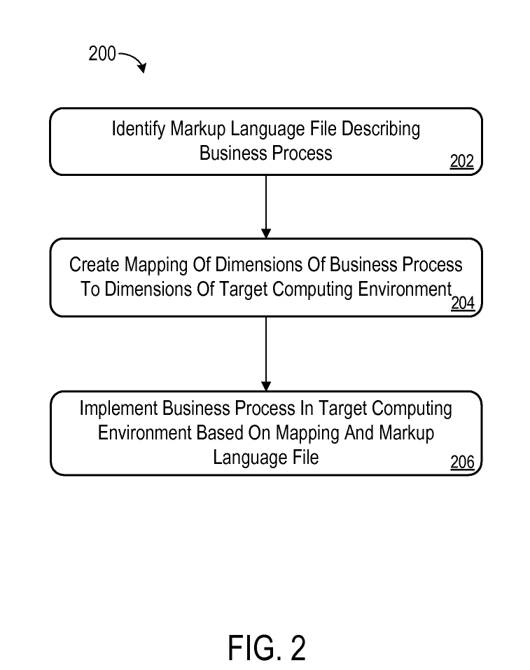

FIG. 2 is a flow diagram of process 200 according to some embodiments. Process 200 may be executed by hardware and embodied in program code stored on a tangible computer-readable medium. System 100 may execute process 200, but embodiments are not limited thereto.

A markup language file describing a business process is initially identified at 202. Injector 110 may receive the markup language file at 202 and/or may identify the markup language file from local storage. In some embodiments, the markup language is uploaded from a Web Browser of a client device to injector 110 at 202.

The markup language file may specify metadata and a structure of the business process. In some embodiments, a plurality of markup language files describing the business process are identified at 202. The markup language files may describe the process in a platform-independent format manner. According to some embodiments, the markup language file(s) identified at 202 is similar to those described in above-mentioned U.S. patent application Serial No. (attorney docket no. 2008P00071US01), the contents of which are incorporated by reference herein for all purposes. In this regard, the markup language file(s) may be structured in a hierarchical folder structure and compressed into a single .zip file.

A mapping is created at 204. The mapping maps dimensions of the business process to dimensions of a target computing environment. The term dimensions, as used herein, will encompass all terms to describe data variables that are or become known. Such terms include, but are not limited to, Online Analytical Processing (OLAP) cube dimensions, properties, attributes, and schemas.

As an example of 204, it will be assumed that the identified markup language file specifies dimensions used during execution of the business process. Dimensions of a target computing environment hosted by application server 120 may be identified at 204 and mapped to the specified dimensions of the business process. As will be described above, the markup language file may specify one or more “applications” (e.g., OLAP cubes, other data structures) associated with the business process. Each of these applications may correspond to several dimensions. Accordingly, 204 may comprise creating mappings between dimensions of each application and dimensions of corresponding applications of the target computing system.

Next, at 206, the business process is implemented in the target computing environment based on the mapping and the markup language file. According to some embodiments, the mapping and the markup language file are provided to a design tool of the target computing environment.

The implemented process may be embodied in program code residing on application server 120. The program code may implement one or more Web Services, process agents, reports, queries, data structures, and/or any other software constructs. The program code may be compatible with an enterprise platform (e.g., SAP NetWeaver™) and may access persisted data structures according to a particular schema (e.g., star schema).

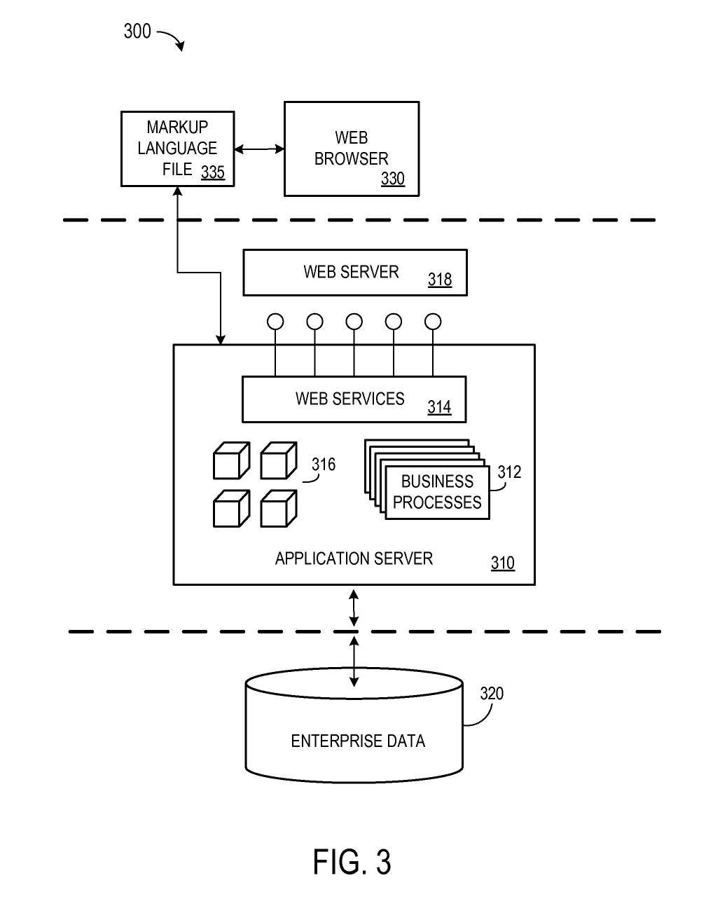

FIG. 3 is a block diagram of a computing architecture according to some embodiments. Architecture 300 generally represents a client-server architecture as is known in the art. Architecture 300 may implement system 100 and/or process 200 described above.

Application server 310 may provide functionality to client devices. For example, application server 310 may access raw data of enterprise data 320 in response to user queries. Application server 310 may also provide business context and logic to assist with the interpretation of the raw data. In this regard, application server 310 may encapsulate the raw data into business objects including both data and related logic.

Application server 310 may provide for the execution of business processes 312. Business processes 312 may comprise any business processes including, but not limited to, those described above. One or more of business processes 312 may be implemented as a Web Service and exposed via Web Services 314.

Application server 310 also embodies data structures 316, which may comprise OLAP cubes. Business processes 312 may utilize data structures 316 as is known in the art. In this regard, a data structure 316 may comprise a “controlling application” for a business process 312. Each of data structures 316 may comprise any number of dimensions, and each dimension is associated with a type. Application server 310 may embody dimensions that are not associated with any data structure, but which may be programmatically associated with a selected data structure. Web Services 314 may also include services for providing information relating to data structures 316 to clients.

Web Server 318 may embody injector 110 in some embodiments. Certain ones of Web Services 314 that provide for implementation of a business process as described herein may be exposed only to entities located in a same secure environment. Accordingly, Web Server 318 of FIG. 3 is illustrated in the same environment as application server 310.

Web Browser 330 may reside on any suitable device, such as a desktop computer, a laptop computer, a personal digital assistant, a tablet PC, and a smartphone. Web Browser 330 may interact with Web Server 318 using standard protocols to upload markup language file 335 to Web Server 318, and to provide a user-created mapping to Web Server 318. Web Server 318 may then invoke one or more of Web Services 314 to implement a business process in application server 310 based on the mapping and the markup language file.

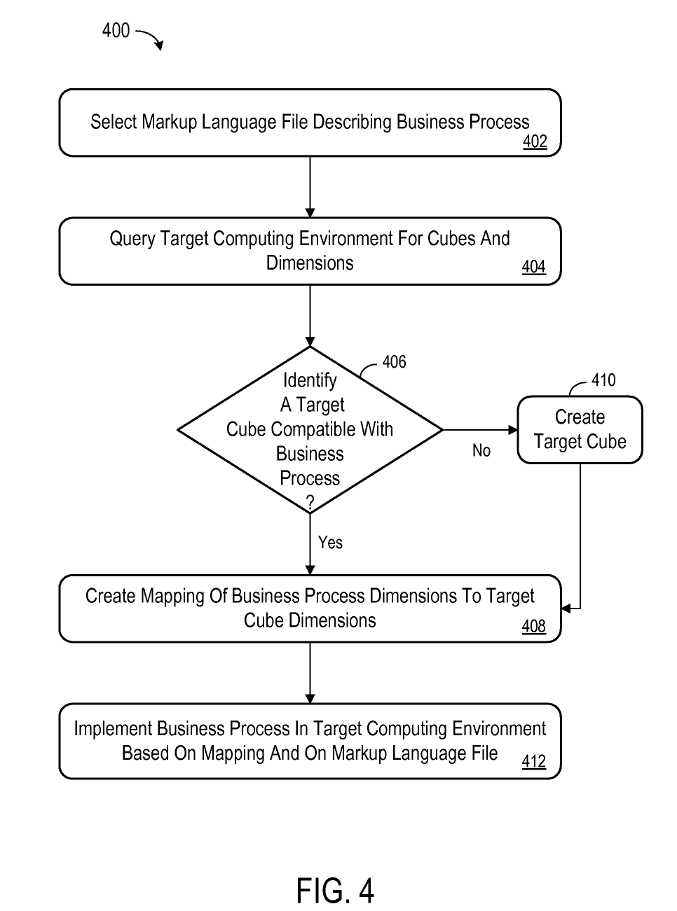

FIG. 4 is a flow diagram of process 400 according to some embodiments. Process 400 may be executed by hardware and embodied in program code stored on a tangible medium. Process 400 may comprise an embodiment of process 200 of FIG. 2. System 100 or system 300 may execute process 400, but embodiments are not limited thereto.

The elements of process 400 will be described with respect to a particular example. Embodiments may differ in part or in whole from the example.

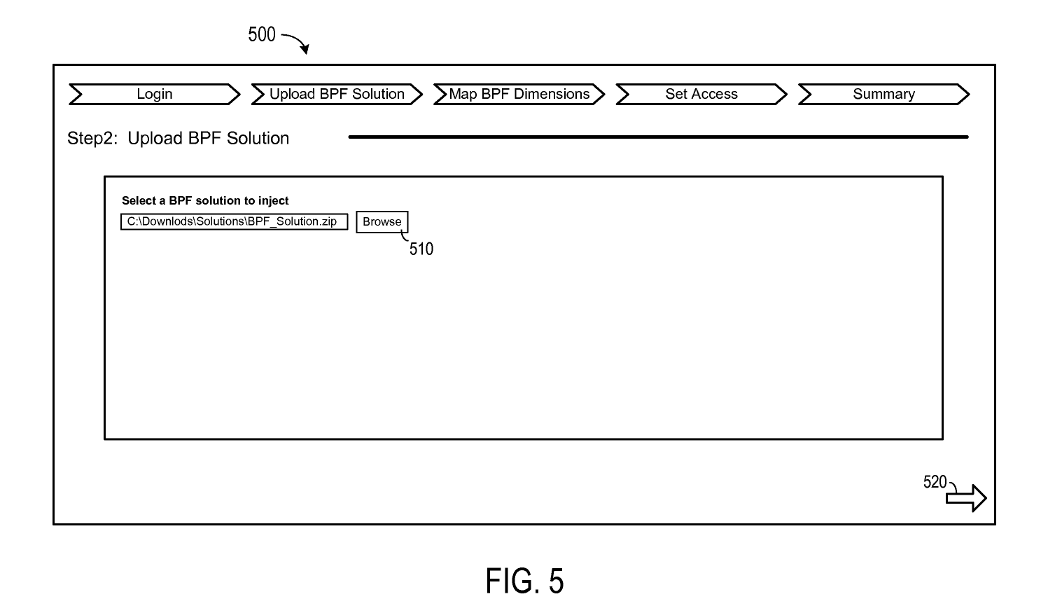

Initially, at 402, a markup language file describing a business process is selected. In some embodiments, a user may operate Web browser 330 to request a Web page served by Web Server 318. FIG. 5 is an outward view of Web page 500 that may be displayed to a user in some embodiments of 402.

Web page 500 includes Browse button 510 which allows the user to select a locally-stored markup language file (e.g., markup language file 335). The markup language file may be one of several markup language files and other files and folders of a .zip file as illustrated and described in U.S. patent application Serial No. (attorney docket no. 2008P00071US01). The .zip file may describe more than one business process (i.e., a collection of business processes) according to some embodiments. The user may select arrow 520 to initiate upload of the selected file to Web Server 318.

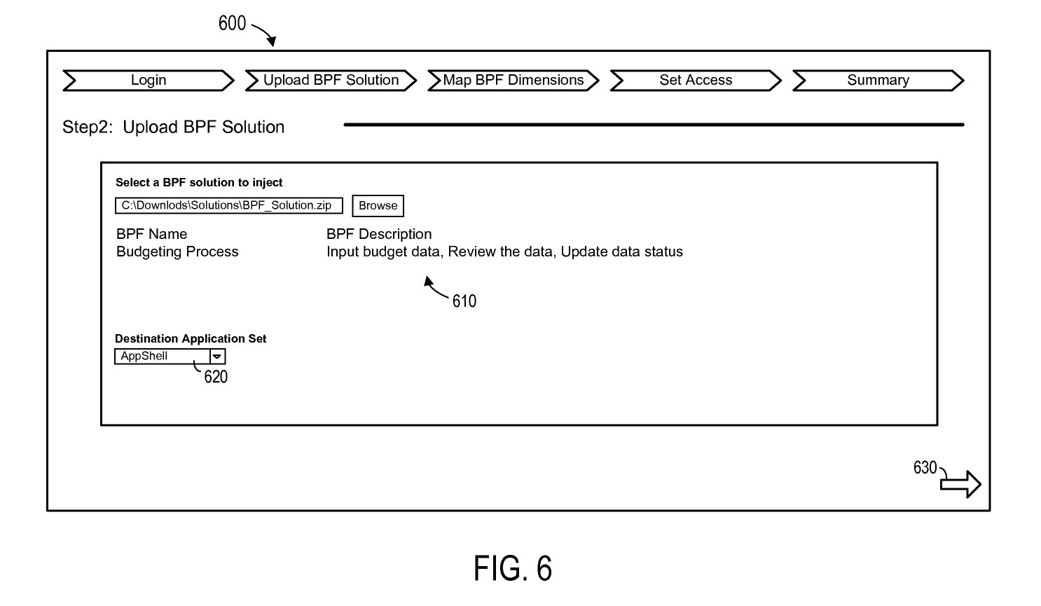

In response, Web Server 318 may call one or more of Web Services 314 to unzip (if necessary) the file and to query application server 310 at 404 for information describing cubes 316 and dimensions of each of cubes 316. Web Server 318 may then construct Web page 600 of FIG. 6 and provide Web page 600 to Web Browser 330.

Web page 600 includes brief description 610 of each business process in the selected collection, and dropdown menu 620. Menu 620 allows the user to specify a set of applications (i.e., cubes 316) of application server 310 which will be used to control the selected business process(es). The user selects arrow 630 after selecting a set of applications in menu 620.

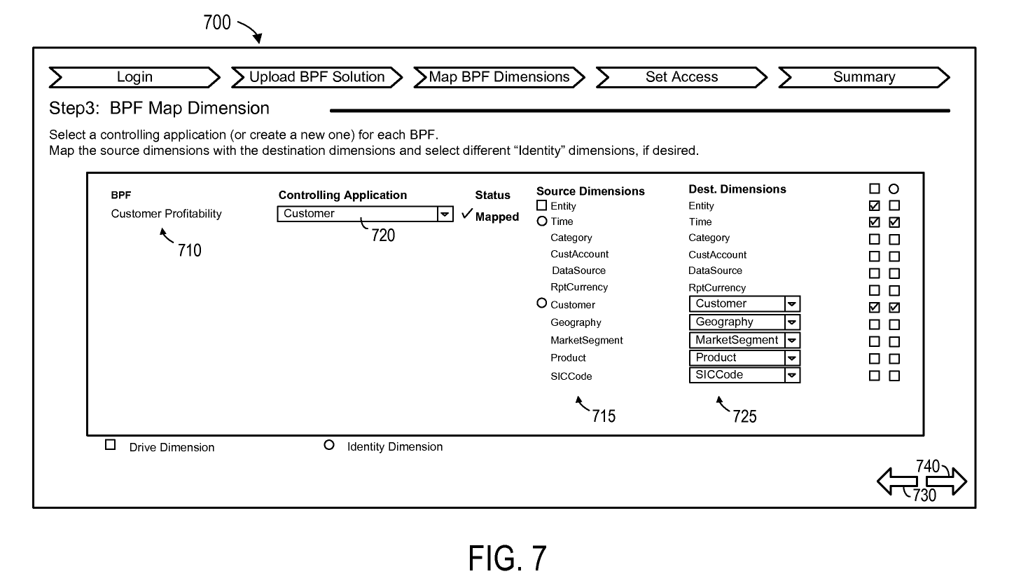

After receiving the selected set of applications, Web Server 318 provides and Web Browser displays Web page 700 of FIG. 7. Web page 700 includes field 710 specifying a business process from the uploaded collection of business processes. Dropdown menu 720 allows the user to identify a target cube (i.e., a controlling application) that is compatible with the business process of field 710 at 406. Selection of a target cube results in display of dimensions 725 of the target cube. Web page 700 may then allow creation of a mapping of dimensions 715 of the business process to dimensions 725 of the target cube at 408.

In some embodiments, the name of the target cube and the names and types of its dimensions match those of the selected business process. Web page 700 may therefore automatically map the dimensions and display the matching dimensions in correspondence with one another as shown in FIG. 7. The only action which may be required in such a case is for the user to map any user-defined Identity dimensions to corresponding user-defined dimensions in the target cube.

If any dimension names and types do not match, Web Server 318 may list dimensions 715 and 725 according to type under the assumption that matching types indicate matching dimensions. Possible types according to some embodiments include Account (A), Category (C), Data Source (D), Entity (E), Inter company (I), Currency (R), Time (T), Sub Table (S) and User Defined (U). In some embodiments, a cube contains exactly one of the following types: Account (A), Category (C), Entity (E), Time (T). According to some embodiments, a cube can contain no more than one of the following types: Account (A), Category (C), Data Source (D), Entity (E), Inter company (I), Time (T), Rate (R), and SubAccount (S).

Any suitable user interface elements may be provided to create the mapping at 410. Some embodiments allow the user to create, through Web Server 318 and Web Services 314, new dimensions for the target cube and to map a dimension of the business process to the new dimension. Some embodiments require a dimension of the target cube which corresponds to each dimension of the business process.

According to some embodiments, flow proceeds from 406 to 410 if no suitable target cube is identified in menu 720. For example, it may be determined at 406 that no target cube includes all of the dimensions associated with the business process. The user creates a new target cube in application server 310 at 410. The new target cube may utilize dimensions which are already defined with respect to another one or more of cubes 316, or which are not associated with any of cubes 316. Dimensions of the business process are then mapped to the dimensions of the new target cube at 408 as described above.

Likewise, if needed dimensions or other metadata constructs do not exist, the suitable object may be created within the target environment for mapping to the new target cube.

Application server 310 may save dimension information in a workbook (e.g., Excel) format. Web Server 318 may therefore include a COM+ application to create and write to such a workbook when creating a dimension as described above. The COM+ application may also handle the above-mentioned unzipping of .zip files.

According to the FIG. 7 embodiment, a user may select arrow 730 to return to Web page 600 and select a new application set instead of proceeding to 408 from 406. A target cube compatible with the business process may then be identified at 406 from the new application set.

Flow continues to 412 upon selection of arrow 740. The business process is implemented at 412 in the target computing environment based on the mapping and the markup language file. According to some embodiments, Web Server 318 provides the mapping and the markup language file to a design tool of application server 310. The design tool is capable of parsing the markup language file(s) based on the schema of the markup language.

The implemented process may be embodied in program code of a new one of business processes 312. The program code may implement one or more Web Services, process agents, reports, queries, data structures, and/or any other software constructs. The program code may access enterprise data 320 according to its particular schema (e.g., star schema).

The embodiments described herein are solely for the purpose of illustration. Those in the art will recognize that other embodiments may be practiced with modifications and alterations limited only by the claims.

What is claimed is:

1. A method comprising:
identifying a markup language file describing a business process;
creating a mapping of dimensions of the business process to dimensions of a target computing environment; and
implementing the business process in the target computing system based on the mapping and the markup language file.

2. A method according to claim 1, further comprising:
determining a plurality of data structures of the target computing environment and dimensions corresponding to each of the plurality of data structures; and
identifying one of the plurality of data structures as compatible with a data structure of the business process,
wherein the mapping comprises a mapping of the dimensions of the data structure of the business process to the dimensions corresponding to the one of the plurality of data structures.

3. A method according to claim 2, wherein determining the plurality of data structures of the target computing environment and the dimensions corresponding to each of the plurality of data structures comprises:
querying the target computing environment for the plurality of data structures of the target computing environment and the dimensions corresponding to each of the plurality of data structures.

4. A method according to claim 3, further comprising:
creating the one of the plurality of data structures in the target computing environment.

5. A method according to claim 2, further comprising:
identifying a second one of the plurality of data structures as compatible with a second data structure of the business process; and
creating a second mapping of the dimensions of the second data structure of the business process to the dimensions corresponding to the second one of the plurality of data structures.

6. A method according to claim 2, wherein creating the mapping comprises:
creating the mapping automatically based on correspondences between types of the dimensions of the data structure of the business process and types of the dimensions of the one of the plurality of data structures of the target computing environment.

7. A method according to claim 1, wherein creating the mapping comprises:
creating the mapping automatically based on correspondences between types of the dimensions of the business process and types of the dimensions of the target computing environment.

8. A method according to claim 1, wherein the markup language file comprises:
metadata of the business process;
data structures for supporting actions of the business process; and
dimension information associated with the business process.

9. A method according to claim 1, wherein implementing the business process in the target computing system comprises:
inputting the mapping and the markup language file to a design tool of the target computing environment.

10. A computer-readable medium having stored thereon program code, the program code executable by a computer to:
identify a markup language file describing a business process;
create a mapping of dimensions of the business process to dimensions of a target computing environment; and
implement the business process in the target computing system based on the mapping and the markup language file.

11. A medium according to claim 10, the program code further executable by a computer to:
determine a plurality of data structures of the target computing environment and dimensions corresponding to each of the plurality of data structures; and
identify one of the plurality of data structures as compatible with a data structure of the business process,
wherein the mapping comprises a mapping of the dimensions of the data structure of the business process to the dimensions corresponding to the one of the plurality of data structures.

12. A medium according to claim 11, wherein determination of the plurality of data structures of the target computing environment and the dimensions corresponding to each of the plurality of data structures comprises:
querying of the target computing environment for the plurality of data structures of the target computing environment and the dimensions corresponding to each of the plurality of data structures.

13. A medium according to claim 12, the program code further executable by a computer to:
create the one of the plurality of data structures in the target computing environment.

14. A medium according to claim 11, the program code executable by a computer to:
identify a second one of the plurality of data structures as compatible with a second data structure of the business process; and
create a second mapping of the dimensions of the second data structure of the business process to the dimensions corresponding to the second one of the plurality of data structures.

15. A medium according to claim 11, wherein creation of the mapping comprises:
creation of the mapping automatically based on correspondences between types of the dimensions of the data structure of the business process and types of the dimensions of the one of the plurality of data structures of the target computing environment.

16. A medium according to claim 10, wherein creation of the mapping comprises:
creation of the mapping automatically based on correspondences between types of the dimensions of the business process and types of the dimensions of the target computing environment.

17. A medium according to claim 10, wherein the markup language file comprises:
metadata of the business process;
data structures for supporting actions of the business process; and
dimension information associated with the business process.

18. A system comprising:
a target computing system exposing web services; and
an injector to identify a markup language file describing a business process and to create a mapping of dimensions of the business process to dimensions of a target computing environment,
wherein the web services are to implement the business process in the target computing system based on the mapping and the markup language file.

19. A medium according to claim 18, the injector further to:
determine a plurality of data structures of the target computing environment and dimensions corresponding to each of the plurality of data structures; and
identify one of the plurality of data structures as compatible with a data structure of the business process,
wherein the mapping comprises a mapping of the dimensions of the data structure of the business process to the dimensions corresponding to the one of the plurality of data structures.

20. A system according to claim 19, the injector further to create the one of the plurality of data structures in the target computing environment.
